(19) United States
(12) Patent Application Publication
(10) Pub. No.: US 2011/0035208 A1
(43) Pub. Date: Feb. 10, 2011

(54) System and Method for Extracting Radiological Information Utilizing Radiological Domain Report Ontology and Natural Language Processing

(76) Inventors: Charles R. Hale, Trumbull, CT (US); Donald E. Satz, New Rochelle, NY (US); Yihong Ding, Westport, CT (US)

Correspondence Address: Woods Oviatt Gilman LLP, 700 Crossroads Bldg, 2 State St., Rochester, NY, 14614, US

(21) Appl. No.: 12/625,880

(22) Filed: Nov. 25, 2009

Related U.S. Application Data
(63) Continuation-in-part of application No. 12/535,825, filed on Aug. 5, 2009.
(60) Provisional application No. 61/248,281, filed on Oct. 2, 2009.
(60) Provisional application No. 61/248,299, filed on Oct. 2, 2009.

(51) Int. Cl. G06F 17/27; G10L 21/00

(52) U.S. Cl. 704/9; 704/270; 704/E11.001

(57) ABSTRACT

A system and method that employs radiological report domain ontology and natural language processing to specify and model historical radiological information as knowledge is provided. The system and method trains a statistical probability based natural language processing system to recognize the semantics of a radiological domain. A methodology is provided to submit portions or the entire content of textual historical radiological report to a natural language processor wherein such data is interpreted and reported in a structured hierarchy.

### CROSS REFERENCE TO RELATED APPLICATIONS

This application is a continuation-in-part of prior U.S. patent application Ser. No. 12/535,825, filed Aug. 5, 2009. This application also claims the benefit of U.S. patent application Ser. No. 61/248,281, filed Oct. 2, 2009 and U.S. patent application Ser. No. 61/248,299, filed Oct. 2, 2009. The content of U.S. patent application Ser. No. 12/535,825, U.S. patent application Ser. No. 61/248,281 and U.S. patent application Ser. No. 61/248,299 are hereby incorporated by reference in their entirety.

### TECHNICAL FIELD

The present invention is directed in general to imaging technologies, and more particularly to medical imaging, medical applications and Picture Archiving and Communication Systems (PACS) pertaining to image display, wherein the identification, validation and classification of radiological information is desired, and wherein historical radiological information can be accessed and utilized in conjunction with natural language processing to offer more meaningful radiological report information. A system and method are provided that will submit all or parts of a textual historical radiological report to a natural language processor to provide structured and meaningful radiological report information.

Even further, a system and method are provided for consulting a radiological report domain ontology to train a statistical based natural language processing system to recognize radiological semantics as modeled in the radiological domain report ontology and provide results that reflect that model. Users or other applications systems are able to quickly, accurately and consistently provide input in context and receive hierarchical knowledge that is based on the report domain ontology.

### BACKGROUND OF THE INVENTION

In medical imaging, PACS are a combination of computers and/or networks dedicated to the storage, retrieval, presentation and distribution of images. While images may be stored in a variety of formats, the most common format for image storage is Digital Imaging and Communications in Medicine (DICOM). DICOM is a standard in which radiographic images and associated meta-data are communicated to the PACS system from imaging modalities for interaction by end-user medical personnel.

Medical personnel spend a significant amount of their time addressing administrative tasks. Such tasks include, for example, documenting patient interaction and treatment plans, preparing billing, reviewing lab results, recording observations and preparing reports for health insurance. Time spent on performing such tasks diminish the time available for patients, and in some instances lead to inaccurate and hastily compiled reports or records when personnel are faced with the need to see multiple patients.

In order to address time deficiency issues, the current trend in the medical field is to automate as many health care related processes as possible by leveraging various technologies, and thereby freeing up personnel to spend more time with patients rather than performing administrative tasks. Another objective in this arena is to ensure that administrative tasks are accomplished in an accurate and consistent manner. One approach to achieving this objective is to provide a standardized representation for healthcare related data, particularly within the various specialty areas, such as radiology, cardiology, etc.

Health care data is not easily reusable by disparate groups in the radiological field because it is stored by different methods and in different formats across a wide range of information technology. Various initiatives by groups and organizations across the globe, including the National Institutes of Health, Food and Drug Administration, and other medical bodies, have driven a set of standards for the consolidation of medical information into a common framework. One such standard is RadLex, which is a standard radiological lexicon proposed by the Radiological Society of North America, for uniform indexing and retrieval of radiology information. RadLex is a taxonomy having class hierarchies. RadLex functions essentially as a dictionary of terms and notes relationships among the terms. RadLex has some crucial limitations. The most significant of these limitations is the inability to support or report radiological findings and the relationships between the findings and the characteristics of the findings. What is needed is an extension to RadLex—an extension that provides domain specific modeling, which can then be applied to, or utilized by, a wide variety of applications such as report tools, treatment analysis programs, tools for classification and verification of radiological information, and systems for improving radiological work flow. Such an extension would utilize an ontology that is domain specific in order to process radiological information.

Ontology is a data model for modeling the concepts and the relationships between a set of concepts. Ontologies are utilized to illustrate the interaction between the set of concepts and corresponding relationships within a specific domain of interest. Thus, the concepts and the relationships between the concepts can be represented in readable text, wherein descriptions are provided to describe the concepts within a specific domain, and the relationship axioms that constrain the interpretation of the domain specific concepts.

Numerous current products and research efforts offer tools that streamline data integration. These include centralized database projects such as the Functional Magnetic Resonance Imaging Data Center and the Protein Data Bank, distributed data collaboration networks such as the Biomedical Informatics Research Network, commercial tools for data organization, and systems for aggregating healthcare information such as Oracle Healthcare Transaction Base. In addition, tools have been developed to automatically validate data integrated into a common framework. Validation calls for techniques such as declarative interfaces between the ontology and the data source and Bayesian reasoning to incorporate prior expert knowledge about the reliability of each source.

While automated data integration and validation require fewer human resources, they necessitate that data have well-defined a priori structure and meaning.

To overcome some of the deficiencies earlier described, some existing systems have attempted to minimize the amount of effort that may be required to report on radiological findings. However, these systems suffer from a myriad of drawbacks. Essentially these solutions do not provide: a standard library or vocabulary; error, terminology, or consistency checking; the ability to utilize and train a natural language processing system; or a collaborative tool or interface that can be used by other application programs to obtain radiological information.

The shortcomings of the prior art are overcome and additional advantages are provided using a method for extracting radiological information from historical radiological reports utilizing a radiological domain report ontology and natural language processing in conjunction with a method for creating and editing structured radiological image report information in real-time to provide and manage knowledge base radiological reports.

The present invention addresses these needs as well as other needs.

### SUMMARY OF THE INVENTION

The present invention is directed in general to a system and method that employs knowledge based radiological report information in conjunction with ontology driven natural language processing, and trains a statistical probability based natural language processing system to recognize the semantics of a radiological domain. The present invention provides a methodology to submit portions, or the entire content, of textual historical radiological report to a natural language processor wherein such data is interpreted and reported in a structured hierarchy.

The radiological domain report ontology declares and fulfills a model of radiological domain report knowledge by employing a context that defines a set of domain report knowledge and the relationships among the set of domain report knowledge with respect to imaging modalities when necessary or appropriate. In other words, this ontology can contain information that is non-modality specific. The invention validates that an informational item of interest from a historical radiological report relating to the subject or imaging modalities is radiological in nature and resides in the domain knowledge. The invention further identifies a definitive concept of the report informational item from within the domain of knowledge and classifies the informational item as an object with properties. The object's properties represent relationships among findings and finding characteristics or concepts.

Exemplary embodiments of the present invention relate to a solution for the extraction of information from sources of historical radiological report information, for example clinical information, patient history, or clinical/surgical consultation. Further, ontological relationships are inferred between the extracted information. The inferred ontological relationships are identified, verified and classified.

### BRIEF DESCRIPTION OF THE DRAWINGS

The above-mentioned features and other features and advantages of this invention, and the manner of attaining them, will become apparent and be better understood by reference to the following description of the invention in conjunction with the accompanying drawings, wherein:

FIG. 1 is an illustrative block diagram of component systems/processes for the implementation of the present invention;

FIG. 2 is an illustrative block diagram of a system architecture illustrating the interaction of the systems of the present invention along with exemplary component modules;

FIG. 3 is a data and flow diagram of an exemplary process of the present invention wherein content is extracted from a historical report and processed with a natural language processor to yield information for a report manager;

FIG. 4 is a block diagram of an exemplary hierarchical report structure provided by the system and method of the present invention; and

FIG. 5 is a block diagram generally illustrating a computing environment in which the invention may be implemented.

### DETAILED DESCRIPTION OF THE INVENTION

Generally, the system and methods described herein and the disclosed embodiments are intended to be illustrative since numerous modifications and variations thereof will be apparent to those of ordinary skill in the art.

This document is organized as follows. In the first section, an overview of the techniques and implementation necessary to provide meaningful radiological report information in accordance with the present invention are provided and described. In the next section, an exemplary implementation of particular features of the present invention for integrating and utilizing components and features of the invention is discussed. Following this, other aspects of the invention as they pertain to the use and function of the invention are discussed. Finally, an exemplary computer environment for the implementation and use of the invention is described.

The present invention employs radiological domain ontology to specify and model radiological report information as knowledge. A system and method are provided to allow for consulting the ontology with extracted historical information in the context of the model the ontology fulfills. Consulting the ontology results in identified, validated and classified radiological report information that is based on the information provided in the consultation.

More specifically, the present invention relates to a solution for the extraction of information from structured or unstructured historical radiological report sources. A set of subject-matter specific relationships are established as a logical foundation for an ontological subject matter domain that is utilized to aide a natural language processor. The subject-matter specific relationships can be derived partially from a pre-existing information source (e.g., RadLex, the radiological lexicon), other ontology, and partially from the knowledge that needs to be modeled for an identified subject. For example, ontology on the subject of mammography will use lumps or masses as topic concepts. The relationships may correspond to disease-specific relationships such as biopsy, additional exam, symptoms, location, further treatments, etc. In another example, clinical indications may be utilized as a concept. In this instance a relationship may correspond to a specific imported ontology that provides a knowledge source, such as anatomic location ontology, follow-up procedure ontology, etc. Once the subject-matter specific relationships have been established, the unstructured/structured knowledge sources are parsed in order to identify topic headings and content texts that are associated with respective topic headings within the knowledge source. The context texts that are identified within the knowledge source correspond to the predetermined subject-matter specific relationship. It should be understood that the source of the unstructured/structured information is a historical report that may be varied and includes such sources as previously spoken words, a user's typing, textual reports or systems or applications that need to determine if a piece of information is suitable for a radiological report.

The present invention utilizes ontology to define a set of knowledge and relationships among the knowledge, thereby employing a context. For example, if there is a finding of a tumorous mass in an image, the system knows what other information would be relevant to that finding, such as size, density, location and other characteristics that apply to that finding, as well as the relationships between the findings and finding characteristics. The set of knowledge includes other specific ontology. The knowledge set may then be applied when a report is being constructed.

Ontological models are used to talk about “things.” An important vocabulary tool is “relations” between things. An ontology model itself does not include the “things,” but introduces classes and relations, which can then be used as a vocabulary for talking about and classifying things. In the field of medicine, ontology is used in solving problems in the field of medical terminology, including the organization of copious amounts of data, the alignment and integration of heterogeneous knowledge, and disambiguates in terminology.

The present invention provides a combination of an intelligent database and system, which can provide not only stored information but also information which can be determined or derived by knowledge of the technical domain.

In an embodiment of the present invention, the radiological report domain ontology is constructed using combinations of one or more of the following World Wide Web Consortium standards:
RDF—Resource Description Framework
RDFS—RDF Schema
OWLDL—Web Ontology Language Description Logic version
   A radiological report domain ontology may be constructed from a radiological domain ontology that defines a plurality of specific concept ontology along with other report concepts.

Although the following discussions and the present invention are described in relation to a biological imaging report system, it should be understood that the invention is also applicable to other information/imaging technologies, systems or reports.

Ontology is a philosophy of what exists. In computer science, ontology is used to model entities of the real world and the relations between them to create common dictionaries for their discussion. Basic concepts of ontology include 1) classes of instances/things, and 2) relations between the classes, as described herein below. Ontology provides a vocabulary for talking about things that exist.

Relations, also referred to as properties, attributes and functions are specific associations of things with other things. Relations can include:
Relations between things that are part of each other, e.g., between a car and its tires;
Relations between things that are related through a process such as the process of creating the things, e.g., a painter and his/her painting; and
Relations between things and their measures, e.g., a tumorous mass and its size.

Some relations also associate things to fundamental concepts such as size, which would be related to large or small, or morphology which would be related to the shape of a mass such as round or linear.

Relations play a dual role in ontology. In one instance, individual things are referenced by way of properties, e.g., a person by a name or characteristic, or music by its title and composer. In another instance, knowledge being shared is often a property of things too. A thing can be specified by some of its properties, in order to query for the values of its other properties.

Not all relations are relevant to all things. It is convenient to discuss the domain of a relation as a “class” of things, also referred to as a category. Often domains of several relations may coincide.

Imaging systems as discussed herein include those wherein image manipulation, image attributes, and features of an imaging system are required to be intuitively and easily analyzed and/or reported, including non-medical systems, visual analysis and diagnostic tools, and other visual user interface environments. Aside from the exemplary environment described herein, the system and method of the present invention is equally applicable to reporting in other radiological domains and for other imaging modalities. The use in other applications or by other systems or tools are anticipated and within the scope of the present invention.

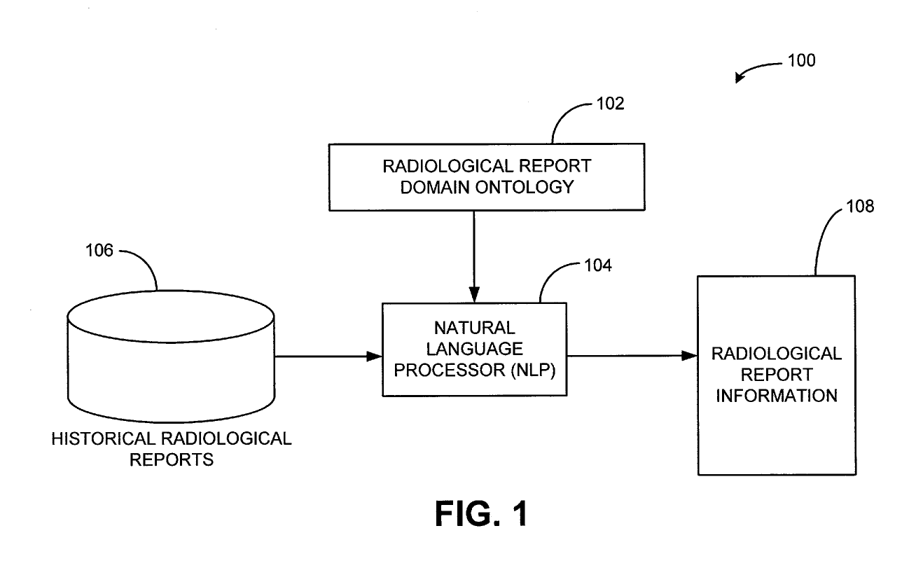

In an embodiment of the present invention, components for the implementation of the present invention may be described as shown in illustration 100 of FIG. 1.

Referring initially to FIG. 1, a radiological report domain ontology 102 that both declares and fulfills a model of radiological report domain knowledge may be utilized to train or aid a statistical probability natural language processor 104. A historical radiological report source 106 may be consulted to extract segments of text or other informational items. The extracted information is processed according to the present invention to obtain meaningful radiological report information 108. Meaningful radiological information as used herein refers to informational items that may be modeled as radiological concepts. The radiological concepts are identified, validated and classified within the context of the radiological report domain ontology 102 or any other ontology that may be utilized in the processing or training of the natural language processor 104. In connection with a particular report that is being considered by a radiologist, an application, a system or a study that is to be reported, there may be a number of concepts. These concepts may themselves be defined by one or more ontology. These ontologies in combination with other concepts may be employed to further construct the radiological report domain ontology 102.

The present invention builds upon the fact that attributes within the realm of radiological knowledge (including diagnosis, anatomic location, and follow-up recommendation, of pathological, physiological, and iatrogenic entities) and pathological, physiological, and iatrogenic observations may be modeled conceptually as radiological domain report ontology to provide validation, identification and classification of radiological report information. Accordingly, the present invention employs the use of the radiological domain report ontology to recognize only the radiological semantics as modeled in the radiological domain report ontology and provide results that reflect that model.

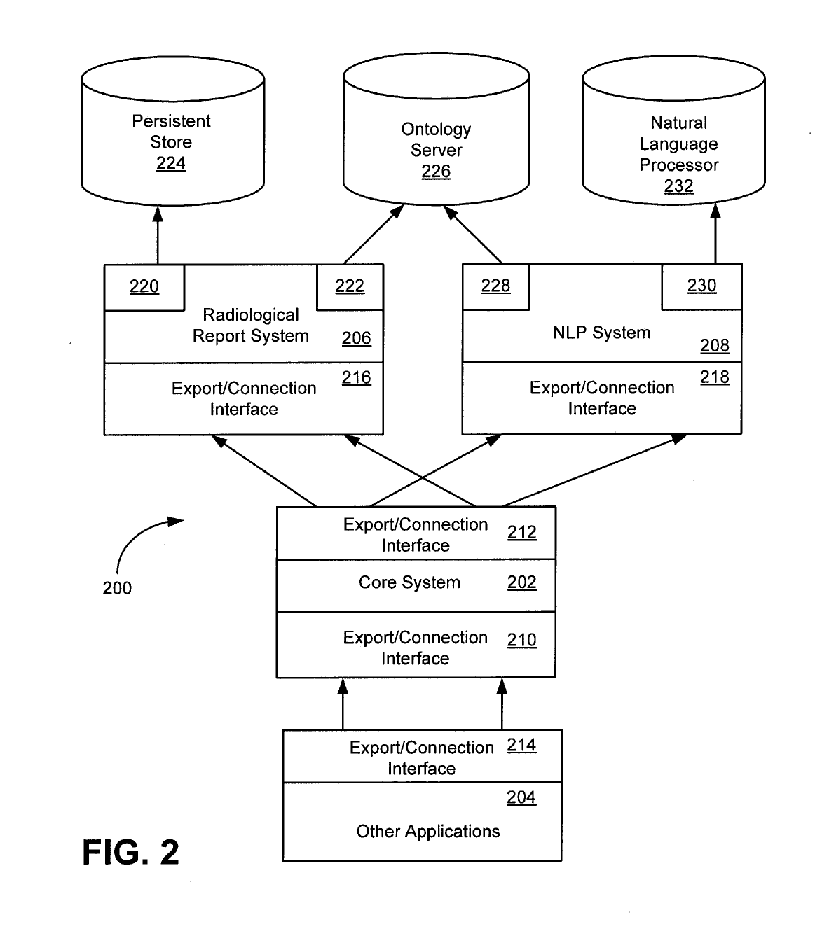

Consistent with the foregoing, the modeled ontology may further contain constraints on radiological findings, radiological finding characteristics, concepts and relationships. Further still, the ontology may also contain concept properties, such as relevance to a modality or impression. It should be understood that certain concepts may be defining concepts from which individual instances may be utilized to represent the vocabulary that describes the concept. A core software system provides connections to other application programs to enable a connection via predefined interfaces. The core software also provides the knowledge and logic to orchestrate the use of several other complex systems to produce meaningful results. This aspect is best described with reference to FIG. 2.

As shown in the system architecture 200 of FIG. 2, the present invention may be implemented in an environment having a core system 202, other applications 204, a radiological report system 206, and a natural language process (NLP) system 208.

The core system 202 comprises an application interface 210 and a systems interface 212. In operation, the application interface 210 and the systems interface 212 may each include separate interfaces for information export and for connections to other components. The application interface 210 provides a connection to other applications 204 via an interface 214. The systems interface 212 provides interfaces to both the radiological report system 206 and the natural language process system 208.

Both the radiological report system 206 and the natural language process system 208 also include interfaces 216, 218, respectively, for interacting with the core system 202. Furthermore, the radiological report system 206 includes a persistent connection 220 and an ontology connection 222. The persistent connection 220 provides interaction with a persistent store 224. The ontology connection 222 provides interaction between the radiological report system 206 and an ontology server 226. In a somewhat similar manner, the NLP system 208 includes an ontology connection 228 for interaction with the ontology server 226. The NLP system 208 also includes an NLP connection 230 for interacting with an NLP module 232.

In operation, the core system 202 further provides the knowledge and logic to orchestrate the use of several other complex systems to produce the meaningful results that were described earlier. A connection is provided to the NLP system 208 that accepts radiological text as input and returns meaningful radiological content from said text. More specifically, the core system 202 provides a connection to the NLP system 208 which has a limited domain of understanding. The domain of understanding is limited to the domain specific radiological report ontology. This limitation results from utilizing the ontology sever 226 as a training aid for the NLP system 208 and/or utilizing the ontology server 226 in real-time to assist with natural language processing. The core system 202 accepts text segments as input and returns hierarchical knowledge that is based on the radiological domain report ontology. Even further, the core system 202 maintains context information and accepts text phrases as input in context.

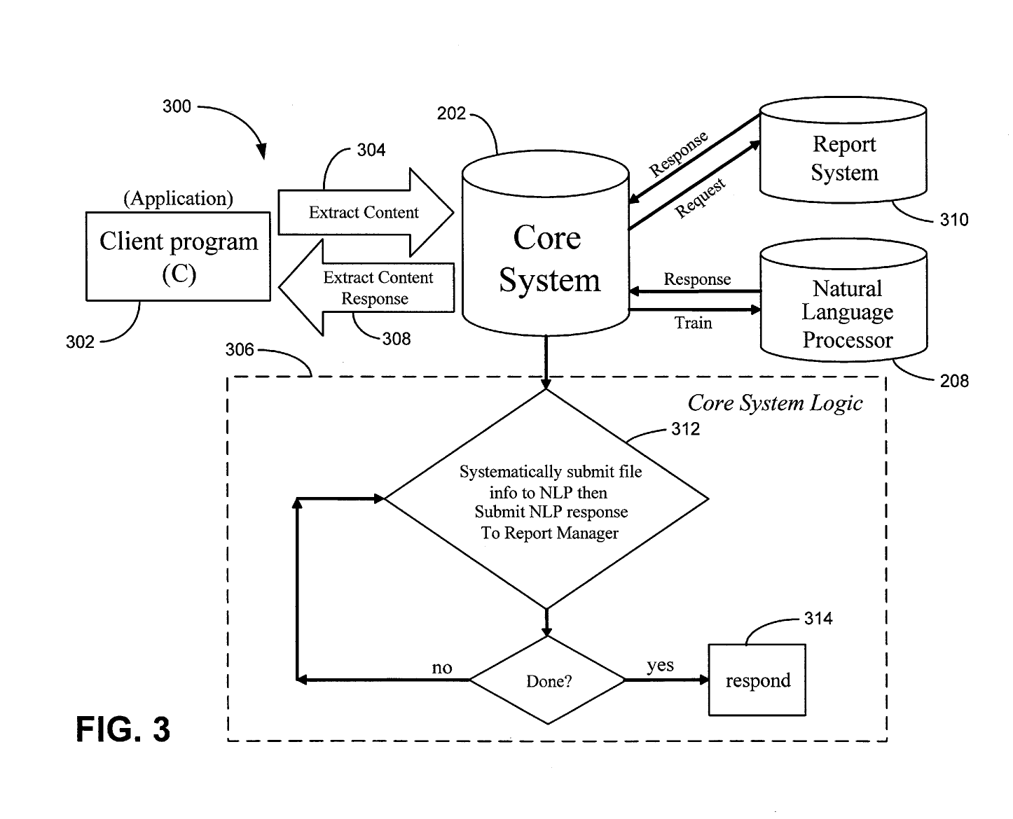

The process of the present invention is initiated by the receipt of a filename for a historical radiological report that is present on the persistent store 224. Thereafter, an analysis is started and content extraction of the report begins. This process of the invention is best described with reference to FIG. 3.

As illustrated in FIG. 3, the present invention provides a system and method for employing the natural language processor in conjunction with a radiological report domain ontology to provide relevant report information and event notifications. A client program C or application 302, initiates an extraction request 304 to the core system 202. In one embodiment of the present invention, the extraction request 304 includes the file name or other identification of a historical radiological report. The core system 202, utilizing the connections earlier described in reference to FIG. 2, communicates to the NLP 208 and also to a report system 310.

Program/or core system logic 306, which may reside on the core system 202 as shown, or reside on another device that has access to the core system 202, accepts the extraction request 304 and provides an extraction response 308. In operation, logic 306 at step 312, makes one or more requests to the NLP 208 and systematically submits file information content to the NLP 208.

One of the other functions performed at this step is the determination of whether the provided file information contains valid radiological report information in the modeled ontology, i.e., the radiological domain report ontology 102. If valid information is contained therein, identification of a definitive concept that resides in the domain is determined. Classification of the file information within the domain is then performed. Following this, a valid response indication, is provided in the report system 310.

Response(s) from the NLP 208 are submitted to the report system 310 via the core system 202. The report system 310 may provide a response to the core system 202 such as, an acknowledgement or other feedback. This process continues until the extraction of information from the subject file is completed as determined at step 312. When extraction and processing, including submissions to the report system 310, is completed, a response is provided at step 314, to the originating application program 302. Notably, during the processing of the extracted file content, the core system 202 of the present invention initiates events to one or more event interfaces to provide process status and updates.

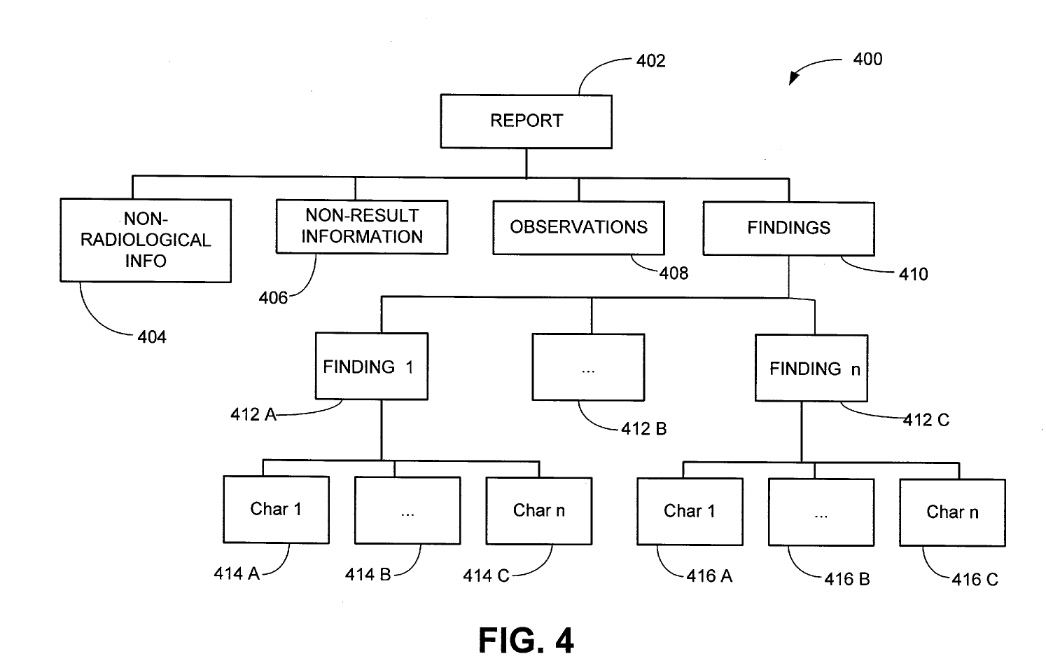

During the processing described above, the extracted information is evaluated by the present invention to determine if the extracted information is in context for the report that is under consideration. In an even further aspect, the present invention provides that for specified valid report concepts, categories are created by the report system 310. In other words, the structure of the presented historical file is analyzed and the obtained information is categorized in the context of the modeled ontology. As previously described, having valid concepts opens the door for further intelligent processing operations by the present invention. This feature is best understood with reference to the illustration of FIG. 4.

FIG. 4 illustrates in a block diagram, an exemplary report categorization or hierarchy 400 in the meaningful radiological report 108 provided by the present invention. To recapitulate, the categorization is derived from the information that is obtained from the historical radiological report 106 and processed by the NLP 104 utilizing the radiological report domain ontology 102.

The hierarchy 400 comprises in one embodiment a report 402 having the following categories: non-radiological information 404, non-result information 406, observations 408 and findings 410. As a category, findings 410 may be further broken-down into a myriad of specific findings such as findings 412A, 412B and 412C. Associated with the findings 412A, 412B and 412C are finding characteristics. Specifically, and as shown, the finding 412A may have finding characteristics 414A, 414B, 414C. Similarly, the finding 412C may have finding characteristics 416A, 416B, 416C. This categorized information is then usable in a new radiological report that can be presented to a user or a calling application program. The new radiological report provides more meaningful and easily understandable information. In other words a complete knowledge based report or historical information is provided by the present invention in a structured format, for use in subsequent processing or review.

To further illustrate an application of the various features and aspects of the invention, an implementation example of the above described invention is next described. In this implementation example, a radiological ontology for breast imaging reporting is utilized.

As a first step, the system and method of the present invention connects to the NLP system. Next a connection is established to the radiological report manager. Following this, interfaces are exposed to allow other systems to interact with the system and method of the present invention.

For example, consider an application that's purpose is to collect historical breast imaging radiological information. Once the application integrates the present invention into its application space, the application gains complete natural language processing capabilities for breast imaging information. In other words, the application “understands” breast imaging terminology. As previously described, the application also exposes known interfaces for interchanges with the system of the present invention. In operation, a user of the application selects a historical radiological report for analysis and content extraction. The application submits the filename of said report to the present invention. Consistent with the process described earlier, the present invention performs the following tasks: opens the report file; employs the natural language processor and radiological report domain ontology; analyzes the structure of the file and roughly breaks the file information into the categories shown and described with reference to FIG. 4, i.e., meaningful report information; creates a new radiological report to hold the meaningful historical report information by utilizing a report manager; methodically adds the historical report information to the new report manager report and notifies the application each time a change to the report occurs by using event triggers—such changes could include those identified by the NLP system or those provided by direct submission (e.g. patient information); and notifies the application when it is done with the report. Consequently, the application obtains a complete knowledge based historical report that it can use as desired.

The process mentioned above involves a consult by the inventive system of the radiological report domain ontology about each piece of purported mammography radiological report information obtained from the historical radiological report. The consult is to validate that the information belongs to the mammography radiological report information domain. The inventive system and method also receives the identity of the information and the classification for the sought after information.

The inventive system and method examines the classification of each piece of information and if one informational item is classified as a mammography radiological concept, then the ontology is consulted in the context of the mammography radiological concept, and any relevant constraints or relationships are explored to validate the concept, i.e., determine whether the radiological report concepts apply to the radiological report currently in consideration.

These steps result in providing radiological report information that has been validated, identified and classified in the mammography report domain ontology.

It should be understood that while the present invention is described in the domain of mammography, it is also applicable to any report domain ontology in the field of radiology.

Having described the system and method of the present invention and an embodiment thereof, an exemplary computer environment for implementing the described design and execution is presented next.

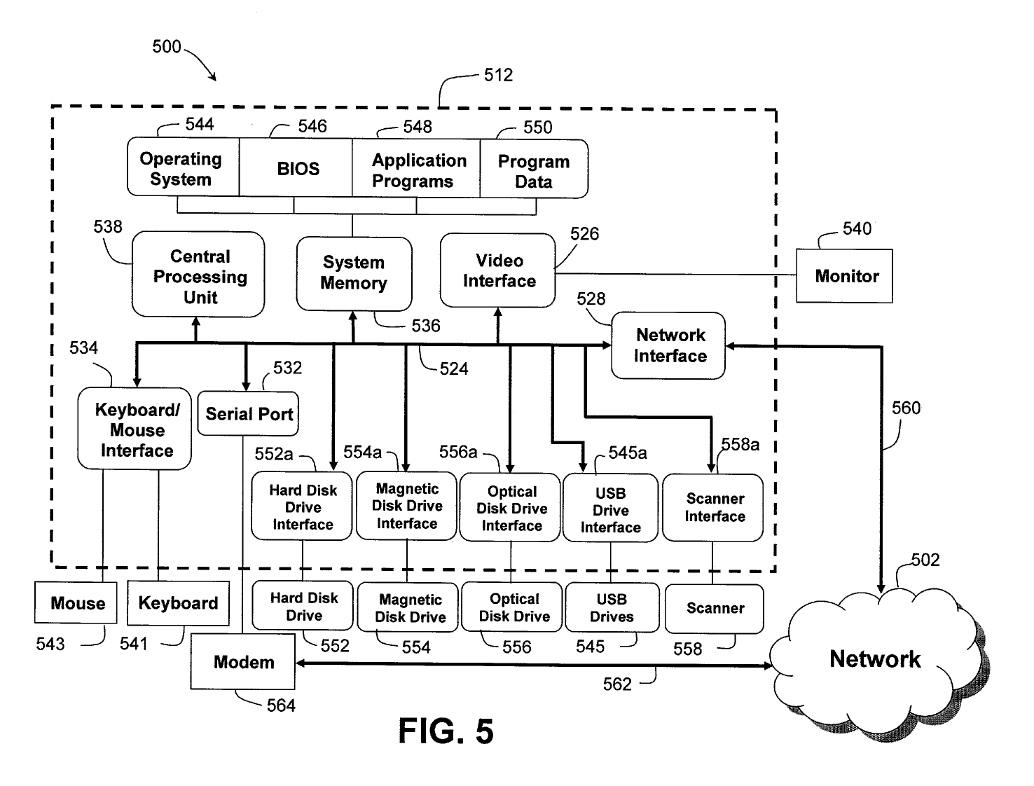

FIG. 5 shows an exemplary computing environment 500 that can be used to implement through programming, any of the processing thus far described. The computing environment may comprise a computer 512 including a system bus 524 that couples a video interface 526, network interface 528, one or more serial ports 532, a keyboard/mouse interface 534, and a system memory 536 to a Central Processing Unit (CPU) 538. Computer 512 may also include a Graphics Processing Unit (GPU) or one or more other special or general purpose processing units. A monitor or display 540 is connected to bus 524 by video interface 526 and provides the user with a graphical user interface to view, edit, and otherwise manipulate digital images. The graphical user interface allows the user to enter commands and information into computer 512 using a keyboard 541 and a user interface selection device 543, such as a mouse or other pointing device. Keyboard 541 and user interface selection device are connected to bus 524 through keyboard/mouse interface 534. The display 540 and user interface selection device 543 are used in combination to form the graphical user interface which allows the user to implement at least a portion of the present invention. Other peripheral devices may be connected to computer 512 through serial port 532 or universal serial bus (USB) drives 545 to transfer information to and from computer 512. For example, CT scanners, X-ray devices and the like may be connected to computer 512 through serial port 532 or USB drives 545 so that data representative of a digitally represented still image or video may be downloaded to system memory 536 or another memory storage device associated with computer 512 to enable processes and functions in accordance with the present invention.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media card), and a scanner 558 for scanning items such as digital images to be downloaded to computer 512. A hard disk interface 552a, magnetic disk drive interface 554a, a optical drive interface 556a, a USB drive interface 545a, and a scanner interface 558a operate to connect bus 524 to hard disk drive 552, magnetic disk drive 554, optical disk drive 556, USB drive 545 and a scanner 558, respectively. Each of these drive components and their associated computer-readable media may provide computer 512 with non-volatile storage of computer-readable instruction, program modules, data structures, application programs, an operating system, and other data for the computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with image capture devices such as MRI, CT scanners, Ultrasound, Positron Emission Tomography (PET) or X-Ray devices. Network interface 528 provides a communication path 560 between bus 524 and network 520, which allows images to be communicated through network 520 from any of the previously identified imaging devices, and optionally saved in a memory, to the computer 512. This type of logical network connection is commonly used in conjunction with a local area network. Images may also be communicated from bus 524 through a communication path 562 to network 520 using serial port 532 and a modem 564. Using a modem connection between the computer 512 and imaging devices may be used in conjunction with a wide area network or the Internet. It will be appreciated that the network connections shown herein are merely exemplary, and it is within the scope of the present invention to use other types of network connections between computer 512 and imaging devices including both wired and wireless connections.

The present invention provides a useful, novel and non-obvious means to utilize radiological report domain ontology to train and interact with a natural language processor to provide validated, identified and classified radiological information for reports. In other words, the present invention provides means to determine what informational items are allowable and/or belong in a given report.

The present invention provides means to extend natural language processing capabilities to a variety of other applications. Even further, the present invention enables natural language processing for a knowledge domain.

Additionally, the present invention provides a tool that may be utilized by other applications or systems as a building block for further information processing.

From the foregoing, it will be seen that this invention is one well adapted to attain all ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed, as the best mode contemplated for carrying out this invention, but that the invention will include all embodiments falling within the scope and spirit of the appended claims.

What is claimed is:

1. A method programmed in a computing environment for providing radiological reporting, the method comprising:
utilizing a historical radiological data source;
extracting one or more informational items from said historical radiological data source to provide said one or more informational items to a natural language processor;
said natural language processor defining select ones of said one or more informational items as report domain concepts of a radiological ontology; and
wherein said report domain concepts are categorized in the context of said radiological ontology to provide a hierarchical radiological report.

2. A method in accordance with claim 1 wherein said one or more informational items is a text phrase.

3. A method in accordance with claim 2 wherein said radiological ontology is a radiological domain report ontology.

4. A method in accordance with claim 3, further comprising providing a status notification as said natural language processor processes said one or more informational items.

5. A method in accordance with claim 4 wherein said notification is provided in response to an event, and wherein said notification indicates that said hierarchical radiological report is completed.

6. A method in accordance with claim 4 wherein said notification is provided in response to an event, and wherein said notification indicates that said hierarchical radiological report is changing.

7. A method in accordance with claim 3, further comprising training said natural language processor utilizing said radiological domain report ontology.

8. A method in accordance with claim 3, further comprising providing an interface to external applications for receiving identification of said historical radiological data source and providing data from said hierarchical radiological report.

9. A method programmed in a computing environment for consulting and providing report information from a historical radiological report, the method comprising:
defining one or more aspects of radiology report information as concept properties represented by a vocabulary of one or more instances of a radiological domain ontology, said radiological domain ontology declaring and fulfilling a model of radiological domain knowledge;
wherein said model of radiological domain knowledge comprises:
one or more findings;
one or more finding characteristics; and
object properties, wherein said object properties represent relationships among said findings and finding characteristics;
extracting from said historical radiological report an informational item of interest;
employing a natural language processor to identify a context that defines a set of said domain knowledge and the relationships among said set of domain knowledge to describe said informational item of interest;
validating said informational item is reportable radiological information and resides in said domain of knowledge;
identifying definitive concept of said informational item from within said domain of knowledge; and
classifying said informational item into a hierarchical report.

10. A method in accordance with claim 9 wherein said classifying step defines said informational item as a finding or finding characteristic.

11. A method in accordance with claim 9, further comprising validating that said informational item of interest is within a specific radiological report context as modeled by said radiological domain ontology.

12. A method in accordance with claim 9 wherein said informational item of interest is based on clinical information.

13. A method in accordance with claim 9 wherein said informational item of interest is based on patient demographic data.

14. A method in accordance with claim 9, further comprising providing a status notification as said information items are validated.

15. A method in accordance with claim 14 wherein said notification is provided in response to an event, and wherein said notification indicates that said hierarchical report is completed.

16. A method in accordance with claim 14 wherein said notification is provided in response to an event, and wherein said notification indicates that said hierarchical report is changing.

17. A method in accordance with claim 9, further comprising training said natural language processor utilizing said radiological domain ontology.

18. A method for providing a knowledge based report of historical breast imaging information to an application program, the method comprising:
interfacing the application program to a natural language processor;
accessing a historical radiological report file including breast imaging information;
said natural language processor employing a mammographic report ontology;
said natural language processor analyzing said historical radiological report file and categorizing said breast imaging information therein to create a new radiological report; and
providing the content of said new radiological report to the application program.

19. A computing system for providing radiological reporting utilizing a radiological report domain ontology in reference to a subject comprising:
a definition of one or more aspects of radiology reports as concept properties represented by a vocabulary of one or more instances of said radiological report domain ontology, said radiological report domain ontology declaring and fulfilling a model of radiological report domain knowledge;
means for receiving an informational report item of interest from a historical radiological report, wherein said informational report item of interest relates to said subject;
a context that employs a set of said radiological report domain knowledge and the relationships among said set of said radiological report domain knowledge to describe said subject;
a validation module to determine that said informational report item of interest is radiological and resides in said radiological report domain knowledge;
an identification module to determine a definitive concept of said informational report item of interest from within said radiological report domain knowledge; and
a classification module for classifying said informational report item of interest as a finding or a finding characteristic within said radiological report domain knowledge; and
a report manager for providing said finding or said finding characteristic in a hierarchical radiological report.
